(19) United States
(12) Patent Application Publication
(10) Pub. No.: US 2026/0010766 A1
(43) Pub. Date: Jan. 8, 2026

(54) PROCESSING STREAMING DATA USING CONVOLUTIONAL NEURAL NETWORKS

(71) Applicant: Silicon Perception Inc., San Francisco, CA (US)

(72) Inventor: Robert Edward Liston, Menlo Park, CA (US)

(21) Appl. No.: 18/765,652

(22) Filed: Jul. 8, 2024

(51) Int. Cl. G06N 3/0464

(52) U.S. Cl. CPC G06N 3/0464

(57) ABSTRACT

A system and method of processing streaming data using convolutional neural networks (CNNs). The method includes receiving, by a CNN, a stream of multidimensional (MD) arrays at a constant data rate. The CNN includes a plurality of interconnected layers of a plurality of convolutional kernels, each interconnected layer of the plurality of interconnected layers is respectively associated with a respective kernel of the plurality of convolutional kernels. The method includes partitioning, by the CNN, a first MD array of the stream of MD arrays into a group of portions. The method includes processing, by the CNN at the data rate, the first MD array to generate a feature map by simultaneously applying a first convolutional kernel of a first layer of the plurality of interconnected layers to each portion of the group of portions to decrease a latency associated with processing the first MD array. The method includes pipelining layers.

### TECHNICAL FIELD

The present disclosure relates generally to artificial intelligence, and more particularly, to systems and methods of processing streaming data using convolutional neural networks (CNNs).

### BACKGROUND

A CNN is a type of deep learning neural network architecture used in computer vision. Computer vision is a field of Artificial Intelligence that enables a computer to understand and interpret the image or visual data. CNNs are distinguished from classic machine learning algorithms such as decision trees by their ability to autonomously extract features at a large scale, bypassing the need for manual feature engineering and thereby enhancing efficiency.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example convolutional neural network (CNN) system that processes a stream of multidimensional (MD) arrays and uses a transformer-based neural network to perform vision-based tasks, according to some embodiments;

FIG. 2 is a block diagram depicting an example streaming CNN in FIG. 1, according to some embodiments;

FIG. 3 depicts a table of an example set of functional parameters that may be used to fully specify (e.g., define) one or more of the Conv2D layers, according to some embodiments;

FIG. 4 depicts a table an example procedure to find optimal implementation parameters which satisfy feasibility constraints, according to some embodiments;

FIG. 5 is a block diagram depicting an example Conv2D layer parameterized hardware that can be realized using a register-transfer level (RTL) code generator 504, according to some embodiments;

FIG. 6 is a block diagram depicting an example parameterized Conv2D data path hardware that can be used to construct the RTL code generator in FIG. 5, according to some embodiments;

FIG. 7a is a block diagram of example adjacent strips that overlap, according to some embodiments;

FIG. 7b is a block diagram of an example procedure for writing input features into a circular row buffer;

FIG. 8a is a block diagram depicting an example control logic, according to some embodiments;

FIG. 8b is a block diagram depicting an S_COUNTER flow chart, according to some embodiments;

FIG. 8c is a flow diagram depicting an example M_FSM flow chart, according to some embodiments;

FIG. 9a is a block diagram depicting a floating point ALU, according to some embodiments;

FIG. 9b depicts a table of values for the floating point ALU in FIG. 9a, according to some embodiments;

FIG. 10a is a block diagram depicting an integer ALU, according to some embodiments;

FIG. 10b depicts a table of values for the integer ALU in FIG. 9a, according to some embodiments;

FIG. 10c depicts a quantization and training of neural networks for efficient integer-arithmetic-only interference, according to some embodiments;

FIGS. 11a-11b depict tables of values representing an example image encoder CNN with 18 layers and 8M weights and based on a TensorFlow model architecture, according to some embodiments;

FIGS. 12a-12b are block diagrams depicting four different types of Conv2D layers for the streaming CNN in FIG. 1, according to some embodiments;

FIG. 13 is a flow diagram depicting a method of using a streaming CNN to process an incoming stream of MD arrays in real-time without having to control the flow rate of the incoming stream of MD arrays, according to some embodiments; and

FIG. 14 is a block diagram of an example computing device 1300 that may perform one or more of the operations described herein, in accordance with some embodiments.

### DETAILED DESCRIPTION

A CNN functions as a trainable feature extractor which converts raw input data, for example RGB pixels (e.g., images) or radio frequency (RF) in-phase and quadrature component (IQ) baseband samples, into a semantic feature map. These semantic features are also known as embeddings, tokens, latents, or representations. A CNN can also be composed with additional downstream models to form a fully differentiable, end-to-end trainable system, making it a valuable general-purpose component.

Although conventional CNNs have been used in a wide range of applications, they do have inherent limitations that prevent them from successfully being used in vision-based applications, such as autonomous robotics, augmented reality/virtual reality (AR/VR) applications, and industrial vision. Namely, a CNN must be able to process a streaming input of MD arrays in real-time to be able to track movements of an object (e.g., human, robot, tennis ball, etc.), where the movements are indicated by the streaming input of MD arrays. However, conventional CNNs are unable to process a streaming input of MD arrays in real-time because they fail to meet the image sensor pixel throughout demands, latency demands, and battery power demands of the vision-based applications. Thus, there is a long-felt but unsolved need to solve the problems of providing a CNN that can process a streaming input of MD arrays in real-time and at a high data rate.

Aspects of the present disclosure address the above-noted and other deficiencies by providing a streaming CNN that can generate a semantic feature map for vision-based tasks from an incoming data stream without having to control the flow rate of the incoming data stream. As discussed in greater detail below, the present disclosure describes a CNN system of streaming CNNs, where each CNN includes the following features that allow the CNN to achieve an efficient hardware implementation. First, within each Conv2D layer of the streaming CNN, OCHAN/OCMUX output channel features may be computed in parallel using dedicated hardware. Second, within each Conv2D layer of the streaming CNN, the streaming CNN 102 may divide the rows into NSTRIP vertical strips (sometimes referred to as portions) which are evaluated in parallel using dedicated hardware. Third, each Conv2D layer of the streaming CNN receives an M_CLK frequency clock which can be tuned so that the time required to compute one row of output features matches the incoming row rate of the stream of MD arrays. These three implementation parameters enable hardware to be generated with sufficient parallelism to closely match the incoming data rate, resulting in very efficient pipelined hardware for the given model architecture and performance requirement. In addition, the overall system is simplified because there are no pipeline stalls.

Furthermore, in the streaming setting, the streaming CNN input and output data are serialized at a maximum row rate. This is a valuable capability because it enables the streaming CNN to process a continuous stream of rasterized pixels directly from an image sensor in real time. Similarly, a streaming CNN can process a stream of RF IQ baseband samples from a Multiple-Input Multiple-Output (MIMO) antenna array.

In an illustrative embodiment, a streaming CNN receives a stream of multidimensional (MD) arrays at a data rate (e.g., greater than 10 gigabits per second (Gb/s)). The CNN includes a plurality of interconnected layers of a plurality of convolutional kernels that each have a shape defined by a height, a width, and a depth. Each interconnected layer of the plurality of interconnected layers is respectively associated with a respective (e.g., dedicated, single) kernel of the plurality of convolutional kernels. The CNN partitions a first MD array of the stream of MD arrays into a group of portions (e.g., vertical strips). The CNN processes, at the data rate or substantially at the data rate, the first MD array to generate a feature map by simultaneously applying a first convolutional kernel of a first layer of the plurality of interconnected layers to each portion of the group of portions to decrease a latency associated with processing the first MD array. For example, the CNN processes, at the data rate or substantially at the data rate the first MD array to generate a feature map by sliding the first convolutional kernel of the first layer of the plurality of interconnected layers across each portion of the group of portions in parallel (e.g., simultaneously). In some embodiments, a portion of an MD array refers to a rectangular region of the MD array.

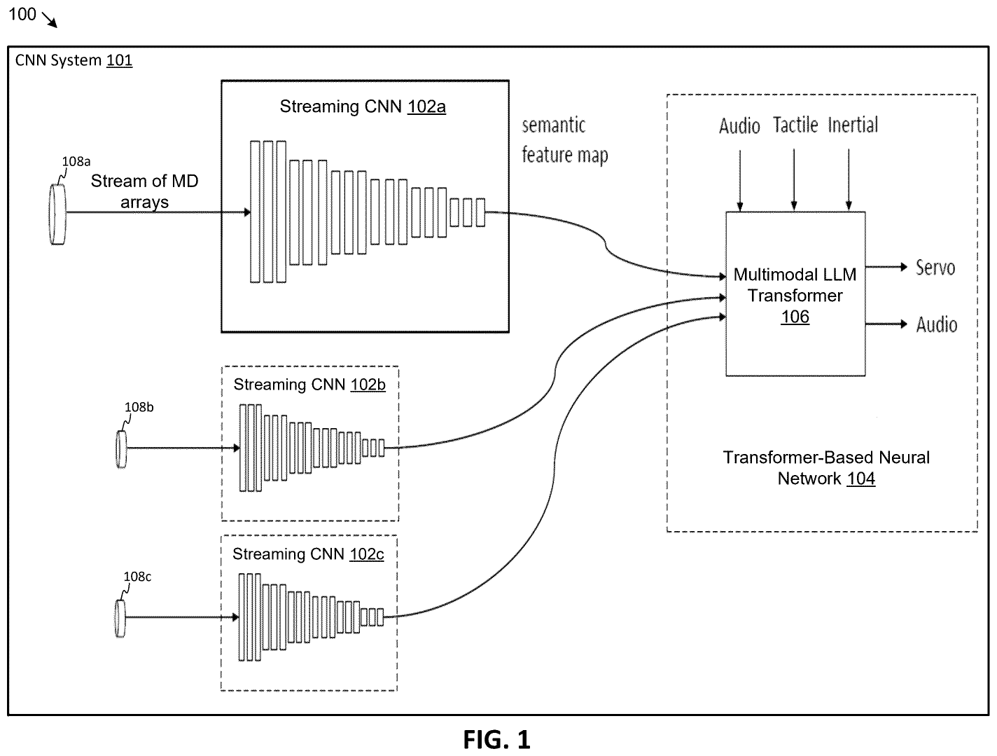

FIG. 1 is a block diagram depicting an example convolutional neural network (CNN) system that processes a stream of multidimensional (MD) arrays and uses a transformer-based neural network to perform vision-based tasks, according to some embodiments. The CNN system 101 includes a plurality of receivers 108 (e.g., receiver 108a, receiver 108b, and receiver 108c), a plurality of streaming CNNs 102 (e.g., streaming CNN 102a, streaming CNN 102b, and streaming CNN 102c), and a transformer-based neural network 104 that are each communicatively coupled via a communication network (e.g., wired bus or wireless connections).

Any number of the components (e.g., receivers 108, streaming CNNs 102, transformer-based neural network 104) of the CNN system 101 may be hardware components that are disposed on the same integrated circuit (IC) device. For example, each of the receivers 108, streaming CNNs 102, and transformer-based neural network 104 shown in FIG. 1 may each be hardware components that are disposed on the same integrated circuit (IC) device (e.g., Field Programmable Gate Array (FPGA) silicon, Application-Specific Integrated Circuit (ASIC) silicon). In another example, receivers 108 and streaming CNNs 102 may be hardware components that are disposed on a first IC device and transformer-based neural network 104 may be a hardware component that is disposed on a second IC device.

In some embodiments, any number of the components (e.g., receivers 108, streaming CNNs 102, transformer-based neural network 104) of the CNN system 101 may execute on one or more computing devices that each include a processing device (e.g., central processing unit (CPU), memory, and data storage. A computing device may be, for example, a server computer (e.g., an application server, a catalog server, a communications server, a computing server, a database server, a file server, a game server, a mail server, a media server, a proxy server, a virtual server, a web server), a desktop computer, a laptop computer, a tablet computer, a mobile device, a smartphone, a set-top box, a graphics processing unit (GPU), and/or the like.

The receiver 108a is configured to receive a stream of MD arrays (sometimes referred to as, incoming input features) and provide the stream of MD arrays to the streaming CNN 102a. The receiver 108b is configured to receive a stream of MD arrays and provide the stream of MD arrays to the streaming CNN 102b. The receiver 108c is configured to receive a stream of MD arrays and provide the stream of MD arrays to the streaming CNN 102c. Each of the receivers 108 are configured to receive a stream of multidimensional MD arrays (e.g., data arranged in rows and columns). The stream of MD arrays may be a stream of multiple images (e.g., Red Green Blue (RGB) pixels), in which case, each of the receivers 108 may include an image sensor that is configured to detect light waves and generate the stream of images from the light waves. Alternatively, the stream of MD arrays may be a stream of RF IQ baseband samples), in which case, each of the receivers 108 may include digitizers to capture and digitize the RF IQ baseband samples.

Each of the streaming CNNs 102 are configured to receive a stream of MD arrays (e.g., a sequence of multiple MD arrays) from its corresponding receiver 108 and process the stream of MD arrays by generating a semantic feature map for vision-based tasks based on the stream of MD arrays. Although the semantic feature map is a low-resolution representation of the stream of MD arrays, it still includes all of the important information about the stream of MD arrays.

Notably, each of the CNNs are capable of processing a stream of MD arrays in real-time without having to control (e.g., delay or pause) the flow rate of the incoming stream of MD arrays, thereby meeting the image sensor pixel throughout demands, latency demands, and battery power demands of transformer-based neural networks that are designed for vision-based applications including, for example, autonomous robotics, augmented reality/virtual reality (AR/VR) applications, and industrial vision. Each of the streaming CNNs 102 then send their semantic feature maps to the transformer-based neural network 104 for vision-based processing.

The transformer-based neural network 104 may be configured for any of the vision-based applications discussed above, for example, autonomous robotics, AR/VR applications, and industrial vision. The transformer-based neural network 104 includes a multimodal large language model (LLM) transformer 106. The multimodal LLM transformer includes an audio input configured to receive audio information, a tactile input configured to receive tactile information, and an inertial input configured to receive inertial information. The multimodal LLM transformer also includes a plurality of semantic feature map inputs that are each configured to receive the semantic feature maps from a particular streaming CNN 102. The multimodal LLM transformer 106 is trained, based on training data, to generate servo information and/or audio information based on one or more semantic feature maps and/or any of the other sets of information (e.g., audio information, tactile information, inertial information). The training data may include sets of semantic feature maps and/or any of the other sets of information (e.g., audio information, tactile information, inertial information).

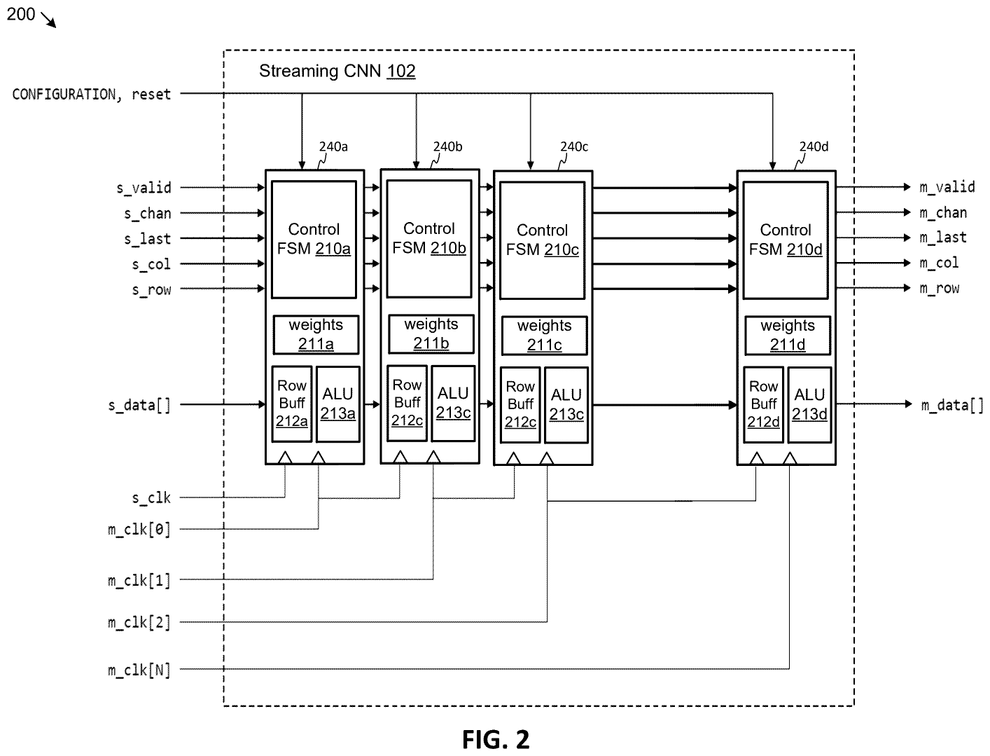

FIG. 2 is a block diagram depicting an example streaming CNN in FIG. 1, according to some embodiments. The streaming CNN 102 includes a plurality of Conv2D layers 240 (e.g., Conv2D layers 240a-240d) that are sequentially connected, such that each Conv2D layer receives information from a previous Conv2D layer and provides information to the next downstream Conv2D layer. For example, Conv2D layer 240a receives a set of inputs (e.g., s_valid, s_chan, s_last, s_col, s_row, s_data[ ]), processes the inputs, generates a set of outputs (e.g., s_valid, s_chan, s_last, s_col, s_row, s_data[ ]), and provides the set of outputs to Conv2D layer 240b.

The plurality of Conv2D layers 240 include a plurality of control finite state machine (FSMs) 210 (e.g., control FSMs 210a-210d), a plurality of weights 211 (e.g., weights 211a-211d), which are sometimes referred to as convolutional kernels or simply kernels, a plurality of row buffers 212 (e.g., row buffers 212a-212d), and a plurality of arithmetic logic unit (ALUs) 213 (e.g., ALUs 213a-213d). Notably, each of the Conv2D layers 240 store their corresponding weights 211 in a memory that is local to the Conv2D layer to decrease the latency time to retrieve the weights during the processing of the stream of MD arrays.

The streaming CNN 102 is a composite function which transforms an input n-dimensional array (e.g., tensor) of shape [IHEIGHT, IWIDTH, ICHAN] into an output tensor of shape [OHEIGHT, OWIDTH, OCHAN] using a fixed sequence of computations, expressed as a computation graph, along with associated weights.

The input, output, and intermediate tensors are serialized using a streaming tensor interface (stream) protocol. The stream protocol consists of signals {clk,valid,chan,last,col,row,data}. It enables tensor data transfers which are interleaved (e.g., out of order) in the channel and column dimensions. Rows are transferred in order. The valid signal qualifies chan and data. The last signal qualifies row and column. The s_data bus includes ICHAN/ICMUX features, each DTYPE bits wide, with the chan signal selecting an offset in the range 0 . . . ICMUX−1. The mapping from s_data to the deinterleaved input channel is defined as channel [i*ICMUX+s_chan]=s_data[i]. The m_data bus is similarly organized with widths determined by OCHAN and OCMUX.

Each Conv2D layer 240 receives an independent, asynchronous m_clk which is used to perform the computation for that Conv2D layer 240. The m_clk is also distributed to the next layer s_clk which ensures that transfers between Conv2D layers 240 are synchronous. In some embodiments, any number of the Conv2D layers 240 may be configured to receive synchronous clocks. Each Conv2D layer 240 logically includes a circular row buffer which stores incoming features in the s_clk clock domain. When a complete row has arrived, the features are read out from the row buffer 212 along with the corresponding weights 211. All NSTRIP strips are read in parallel using the same read address. Using the arithmetic logic unit (ALU) 213, the dot product between the patch and weights is computed, followed by the output activation function (e.g., rectifier linear unit (RELU)). Finally, the output features are serially emitted over the output stream interface. All the row computation operations happen in the m_clk clock domain. There is no output buffer memory, the next layer input buffer is used instead. Features are written to the row buffer using s_clk and read using m_clk, so a true dual port SRAM is utilized to cross the asynchronous boundary. All of this enables fully independent tuning of the clock frequency per model layer.

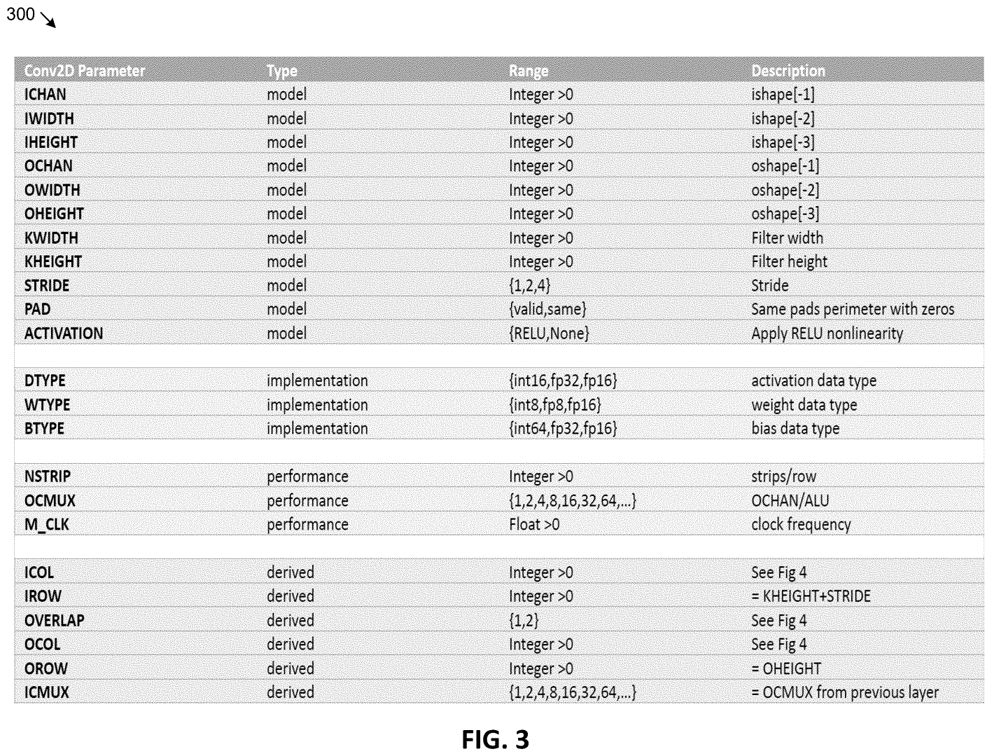

FIG. 3 depicts a table of an example set of functional parameters that may be used to fully specify (e.g., define) one or more of the Conv2D layers, according to some embodiments. The functional parameters are fixed by the model architecture and are derived from the computation graph of the streaming CNN 102, for example using Tensorflow (TF) or Pytorch (PT). A well-known, existing algorithm may be used to evaluate the streaming CNN 102 forward pass inference graph, compatible with TF and/or PT, which enables the use of existing software stacks and tools for training. The streaming CNN 102 can be trained using TF and/or PT, and subsequently the weight and bias values can be extracted and stored in the corresponding Conv2D layer weight memories. The same approach may also be used for scale factors (e.g., integer ALU only). The list of supported functional parameters could be extended to include, for example: dilated convolution, channel grouping, also other nonlinear activation functions such as leaky RELU, tanh, sigmoid, also additional padding modes, also different STRIDE values for vertical and horizontal dimensions. The STRIDE value is a parameter of the convolution operation that refers to the number of pixels by which the filter matrix (weights) moves across the input matrix from the stream of MD arrays. For example, when the stride is 1, the filter moves across the input matrix 1 pixel at a time.

There are three implementation parameters which determine the data types which are implemented in hardware: DTYPE determines the activations, WTYPE determines the weights, and BTYPE determines the bias. The following combinations are shown as examples. For integer implementation mode, DTYPE={int8, int16}, WTYPE={int8}, BTYPE={int64}. For floating point implementation mode, DTYPE={fp8, fp16, fp32}, WTYPE={fp8, fp16}, BTYPE={fp32}. In some embodiments, the formats for fp8, fp16 and fp32 can include any relevant standard (e.g., Institute of Electrical and Electronics Engineers Standards Associations (IEEE), BFLOAT.) There is utility in using different data types within the same model. For example, each layer could use the optimal versions of fp8 (e.g., e5m2, e4m3, e3m4, e2m5) to match the numerical distribution of the layer weights.

The next subset of Conv2D layer parameters control the performance of the layer, without affecting functionality. The controllable performance metric is the time required to compute a single row of output features. In the conventional CNN feature pyramid, the early layers have fewer weights with shallower channel depths, but higher feature map resolution, while the final layers have the most weights, deeper features, and lower feature map resolution.

The following three Conv2D adjustable performance parameters allow the streaming CNN 102 to achieve an efficient hardware implementation over the full range of CNN functional parameters. First, within each Conv2D layer 240, OCHAN/OCMUX output channel features may be computed in parallel using dedicated hardware. Second, within each Conv2D layer 240, the streaming CNN 102 may divide the rows into NSTRIP vertical strips (sometimes referred to as portions) which are evaluated in parallel using dedicated hardware. Third, each Conv2D layer 240 receives an M_CLK frequency clock which can be tuned so that the time required to compute one row of output features matches the incoming row rate of the stream of MD arrays. These three implementation parameters enable hardware to be generated with sufficient parallelism to closely match the incoming data rate, resulting in very efficient pipelined hardware for the given model architecture and performance requirement. In addition, the overall system is simplified because there are no pipeline stalls.

With this set of adjustable performance parameters, it becomes necessary to determine the optimal set of parameter values for a given target application. In some embodiments, the performance parameters may be set manual or by any other type of mechanism (e.g., using a learning-based method).

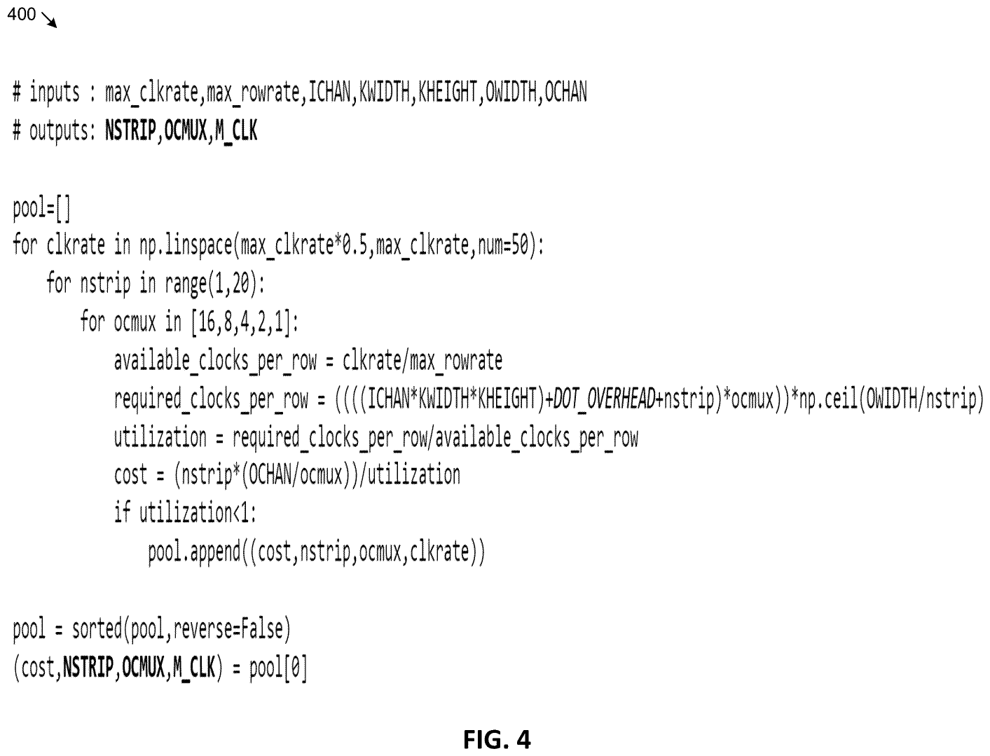

FIG. 4 depicts a table an example procedure to find optimal implementation parameters which satisfy feasibility constraints, according to some embodiments. Given 1) a fixed CNN model architecture for the streaming CNN 120, 2) a performance requirement expressed as maximum input row rate and maximum M_CLK clock rate, 3) a set of feasibility constraints, and 4) a cost function, a processing device can compute an optimized set of parameters {NSTRIP, OCMUX, M_CLK} according to the following operations. First, feasibility constraints can be used to restrict the range of the adjustable performance parameters NSTRIP, OCMUX, M_CLK to a discrete set that can be enumerated using an exhaustive sweep. For example, in FIG. 4 the number of feasible discrete values are NSTRIP=20, OCMUX=5, M_CLK=50, producing 20*5*50=5000 combinations which can be exhaustively searched. For each combination of {NSTRIP, OCMUX, M_CLK}, the processing device then computes the available and required clocks per row. An additional feasibility constraint (e.g., required clocks<available clocks) is then applied to ensure that the computation of a row of output features is completed before the required deadline. Next, a cost function is computed which determines the optimality metric of the set of implementation parameters. For example, the cost function could be a metric which minimizes the total number of ALU units while maximizing the utilization (e.g., required/available), as shown in FIG. 4. All feasible combinations of {NSTRIP, OCMUX, M_CLK} are added to a list and sorted by cost. The lowest cost combination can then be selected as optimal, as shown in FIG. 4.

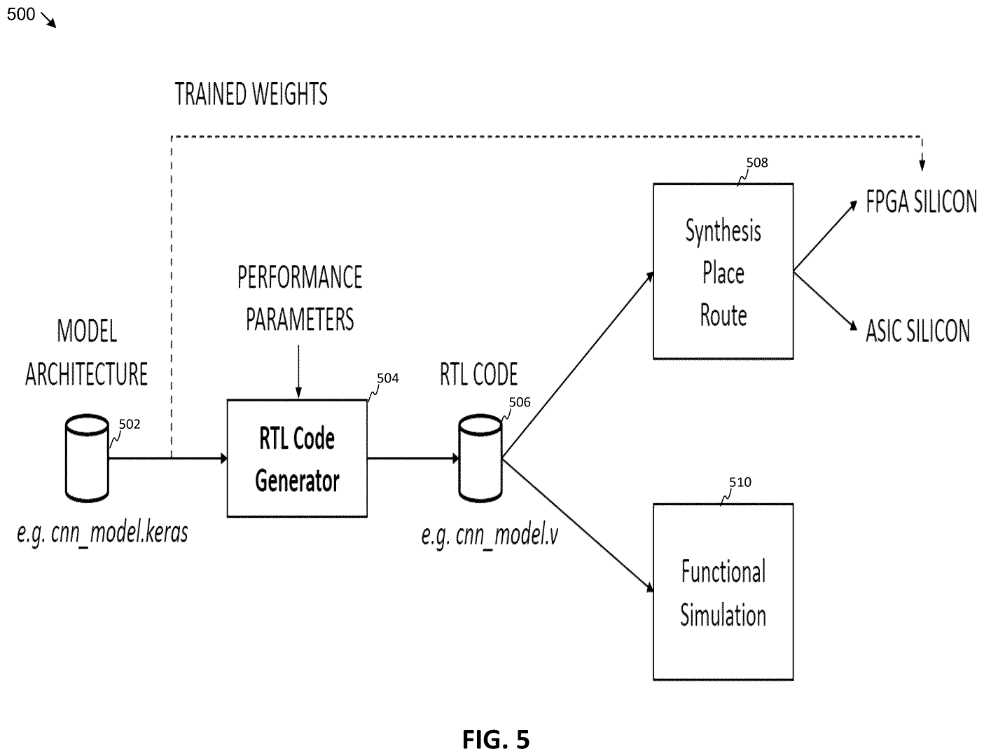

FIG. 5 is a block diagram depicting an example Conv2D layer parameterized hardware that can be realized using a register-transfer level (RTL) code generator 504, according to some embodiments. A processing device provides a model architecture file 502 to an input of the RTL code generator 504. The model architecture file 502 includes the CNN functional parameters, weights, and the adjustable performance parameters. The RTL code generator 504 produces synthesizable RTL code 506 (e.g., Verilog, Very High Speed Integrated Circuit Hardware Description Language (VHDL)) which can be compiled into an FPGA bitstream or hardened into an ASIC implementation. Additionally, the RTL code 506 can be simulated to verify that the functionality matches the TF/PT reference. This enables the use of industry standard Electronic Design Automation (EDA) tools and libraries for hardware implementation and testing. In some embodiments, the trained weights can be incorporated into the hardware using Static Random-Access Memory (SRAM) weight storage or by hardening using read-only memory (ROM). The top-level module (e.g., streaming CNN 102 in FIG. 2) can be realized using structural Verilog or an equivalent netlist format, for example Berkeley Logic Interchange Format (BLIF). Parameterized control logic, for example a finite state machine (FSM), may reference Verilog parameters or macros, and/or can be generated using parameterized RTL code generation.

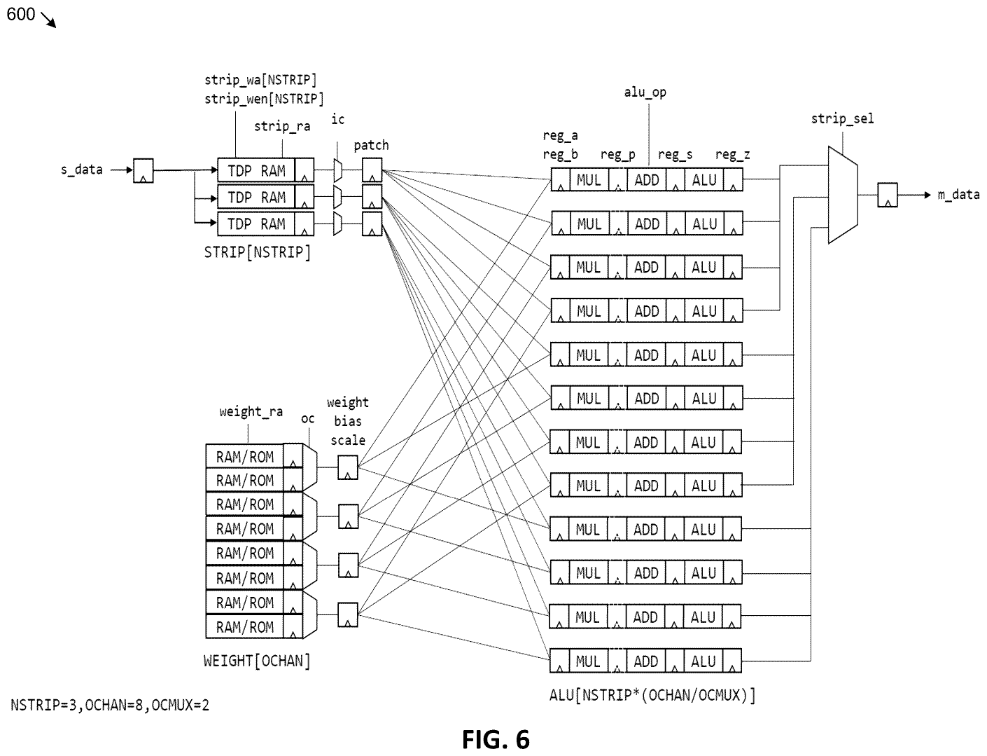

FIG. 6 is a block diagram depicting an example parameterized Conv2D data path hardware that can be used to construct the RTL code generator in FIG. 5, according to some embodiments. That is, FIG. 6 shows the data path hardware for a representative Conv2D layer with NSTRIP=3, OCMUX=2, OCHAN=8. The incoming features from the previous layer arrive on the s_data bus and are optionally registered. The s_data bus is organized as ICHAN/ICMUX channels, each DTYPE bits wide. When s_valid==1, s_data is written into port A of either one or two of the NSTRIP true dual port strip memories. The strip_wa[i] strip write addresses are a function of s_row, s_col, s_chan and an iterator i=0: NSTRIP-1. The strip_wen[i] strip write enables are a function of s_valid, s_col and iterator i=0: NSTRIP-1.

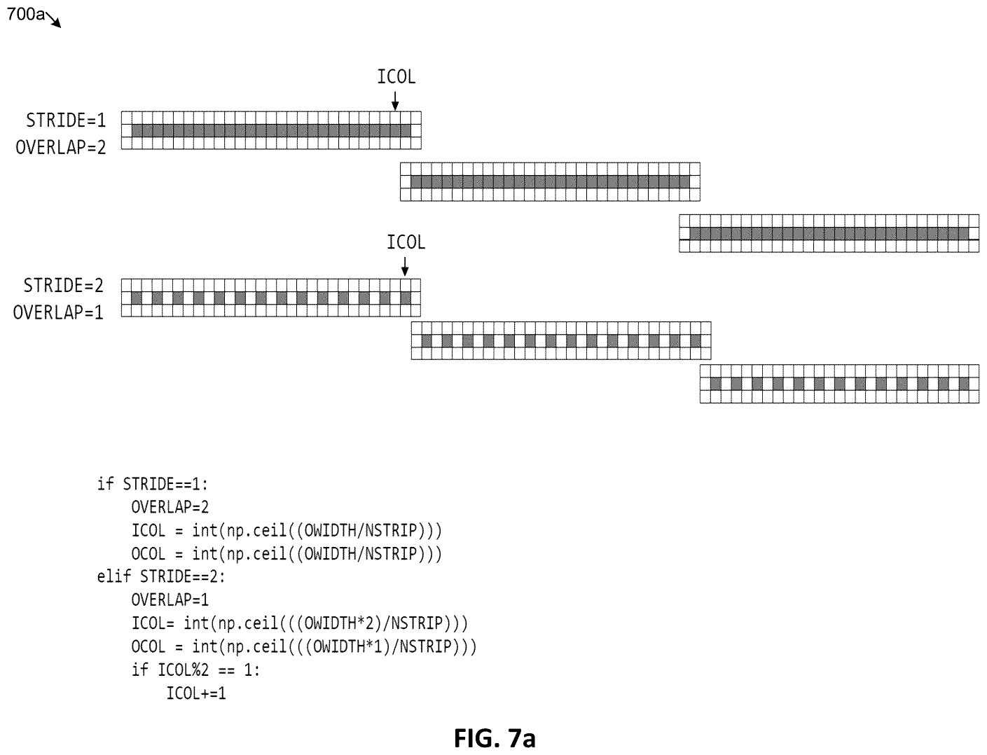

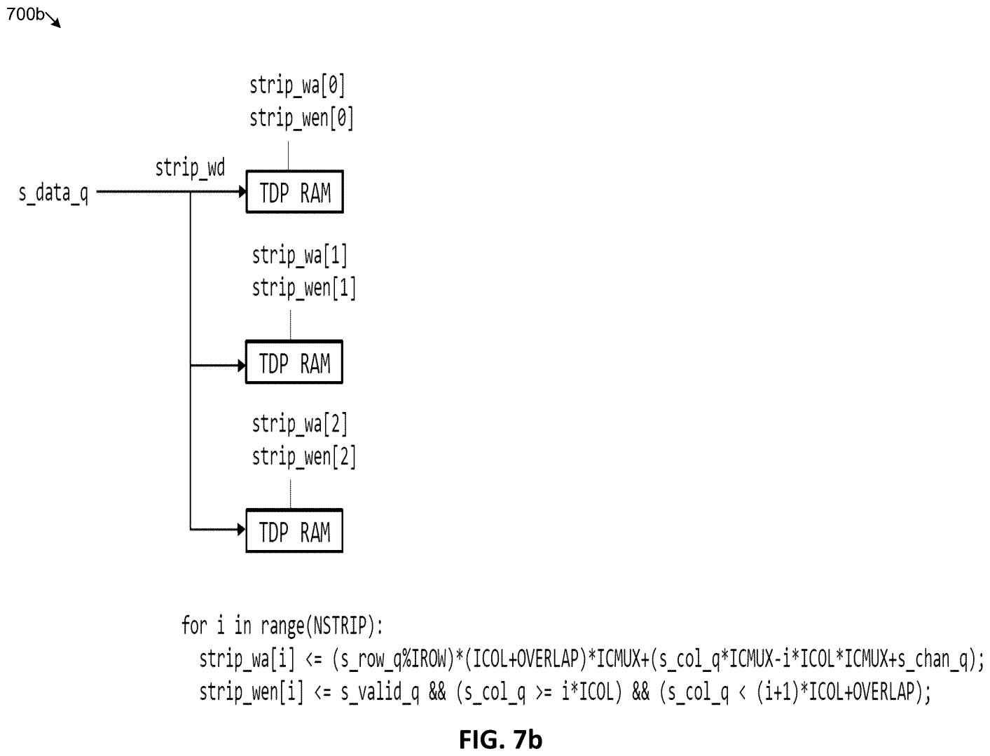

FIG. 7a is a block diagram of example adjacent strips that overlap, according to some embodiments. FIG. 7b is a block diagram of an example procedure for writing input features (e.g., s_data) into a circular row buffer.

Referring to FIGS. 6 and 7a-7b, ICMUX clock cycles are used to transfer a complete input feature and store it into the STRIP memory. Each dual port strip memory is logically organized as a two-dimensional array with IROW rows, ICOL+OVERLAP columns, and each location storing a partial feature vector using (ICHAN/ICMUX)*DTYPE bits. The incoming input features are stored in the strip buffer in column-first order, wrapping around to form a circular buffer. To produce a seamless row of output features, the NSTRIP strips must be overlapped by a STRIDE dependent amount. This ensures that all NSTRIP strips can be read using a common read address.

Port B of the dual port strip memory is clocked using m_clk and is used to read the features from each patch, at each column location. Each dot product (e.g., weighted sum) between the input patch and the corresponding weights is computed sequentially. There is a multiplexer which selects one input channel using the control signal ic and broadcasts the feature to the OCHAN/OCMUX ALU units. This procedure is repeated for each strip.

The weights for each layer are stored in a locally instantiated single port memory, with a shared read address weight_ra. There is a multiplexer which selects 1: OCMUX output channel weights using the control signal oc to select. The weights are then broadcast to each strip of ALU units, as shown in FIG. 6. Using this data path hardware, the dot product for the OCHAN/OCMUX output channels are computed in parallel using dedicated ALU units.

The patch and weight signals are directly connected to corresponding ALU units, which are replicated NSTRIP*(OCHAN/OCMUX) times. The ALU is responsible for computing the dot product between the patch and the weights, adding the bias, and applying the nonlinear output activation function. This process is controlled by the FSM control logic. When the output features have been computed they are emitted sequentially per-strip to the next layer, using a multiplexer with control signal strip_sel as a select.

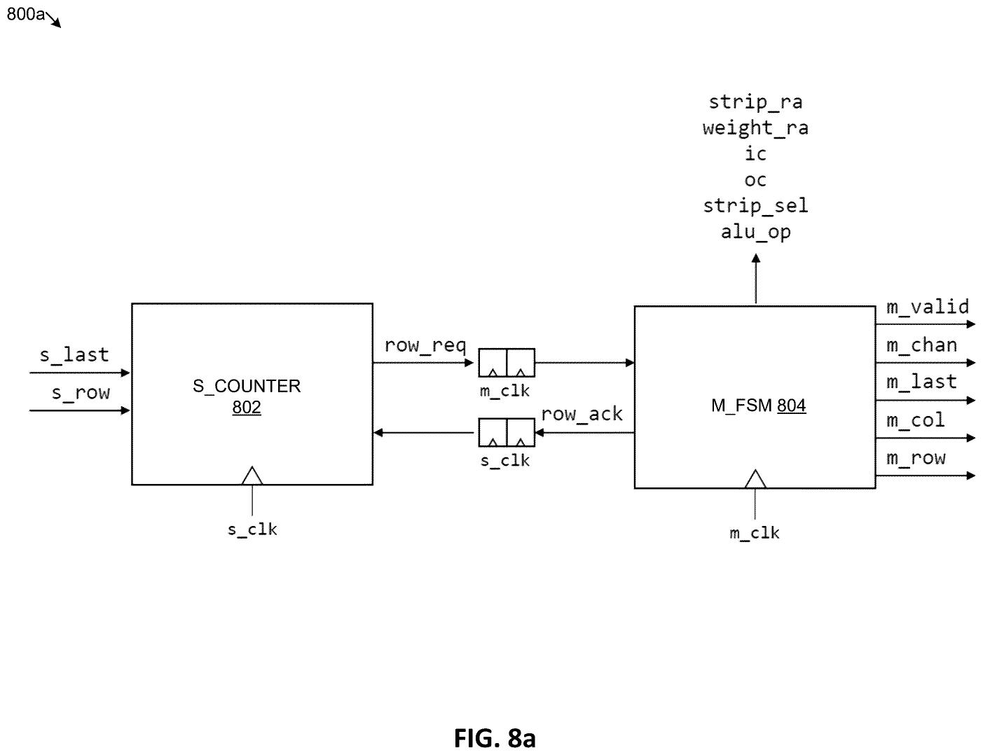

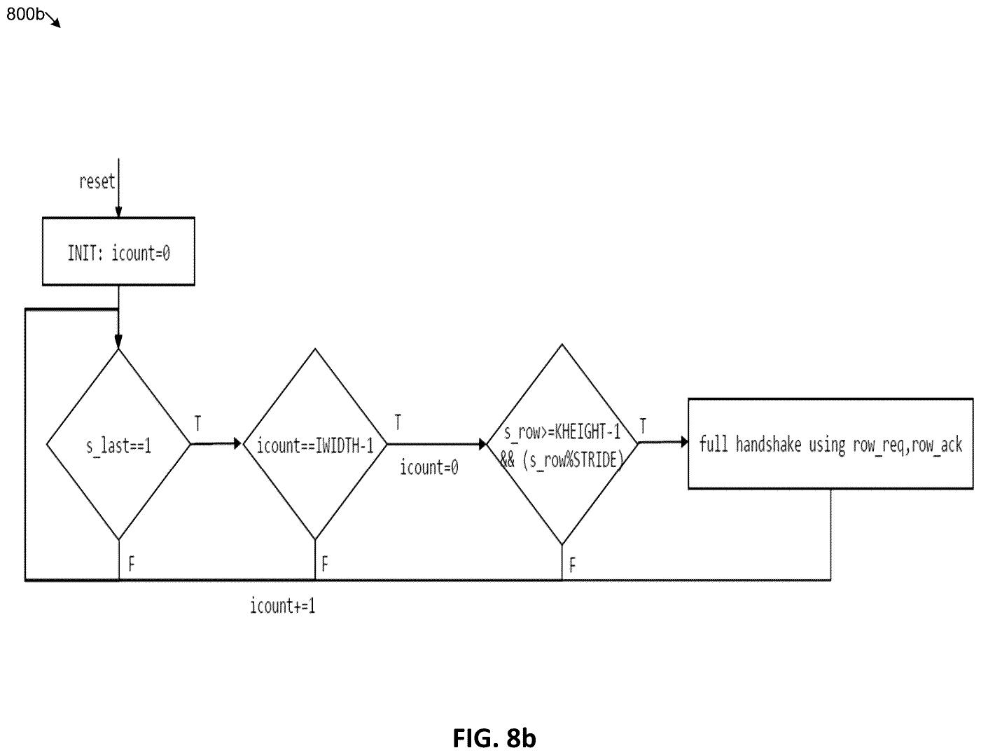

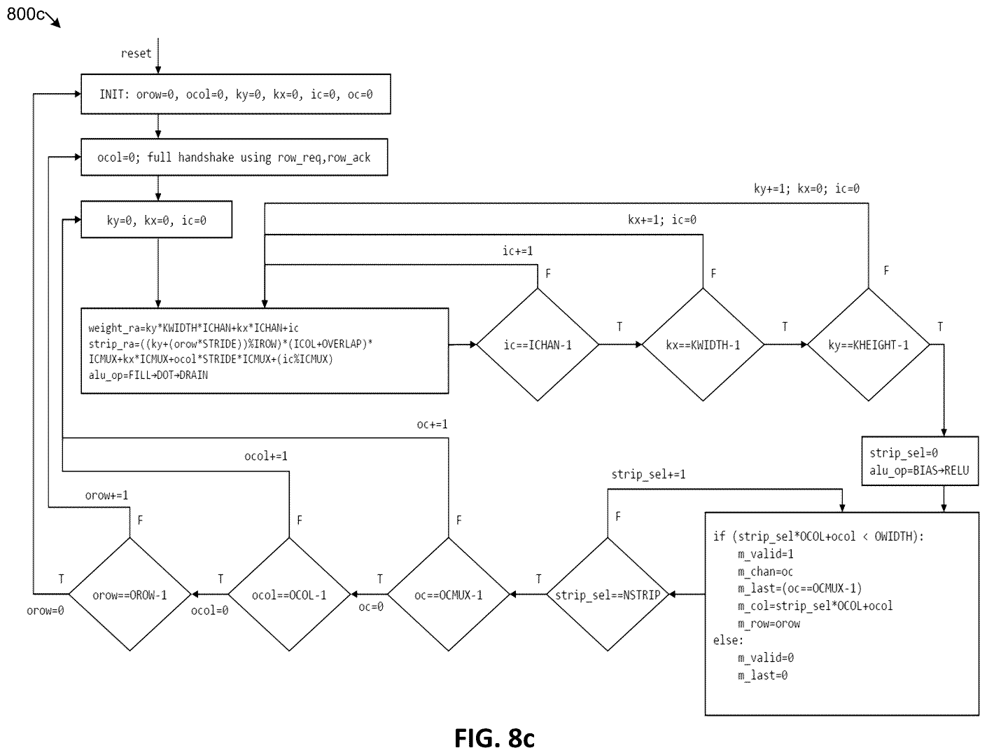

FIG. 8a is a block diagram depicting an example control logic, according to some embodiments. FIG. 8b is a block diagram depicting an S_COUNTER flow chart, according to some embodiments.

Referring to FIGS. 8a-8b, the corresponding control logic contains a state machine S_FSM (shown in FIG. 8a as S_COUNTER 802) in the s_clk domain which counts incoming features and initiates the row computation whenever a complete row of input patches has arrived. In some embodiments, the KHEIGHT*STRIDE rows must be received before the first row is processed. In the case STRIDE==2, rows are only processed on odd rows, so the output row rate is effectively cut in half. To initiate the computation of the output features, the S_FSM performs a full handshake across the asynchronous boundary to the m_clk clock domain. Technology appropriate synchronizer flip flops are used on the request and acknowledge signals in the full handshake. The row strip buffers contain KHEIGHT+STRIDE rows, logically arranged circularly, with STRIDE extra rows so that incoming features can be continuously stored while the output features are computed.

Simultaneously in the m_clk clock domain, state machine M_FSM 804 responds to row_req by initiating a parameterized control sequence which generates the control signals for the data path and the output stream protocol control signals. The data path control signals include memory address lines, write enables, and mux selects.

FIG. 8c is a flow diagram depicting an example M_FSM flow chart, according to some embodiments. The M_FSM 804 iterates through a sequence of nested loops which produce a sequence of final output features. There is an inner loop which takes ICHAN*KWIDTH*KHEIGHT clocks and uses the control signal alu_op to compute the dot product between the patch and the weights. The bias is then added, and the optional output activation is applied, which is by default a rectified linear unit (RELU). After that, there is a loop which emits the NSTRIP output features sequentially using the output stream interface. Next, the nested outer loop performs the inner loop OCMUX*OCOL times to produce one output row, before completing the full handshake and waiting for the next input row. Finally, the outermost loop runs OROW times to produce the full output tensor.

The ALU unit can be implemented using either integer or floating point arithmetic.

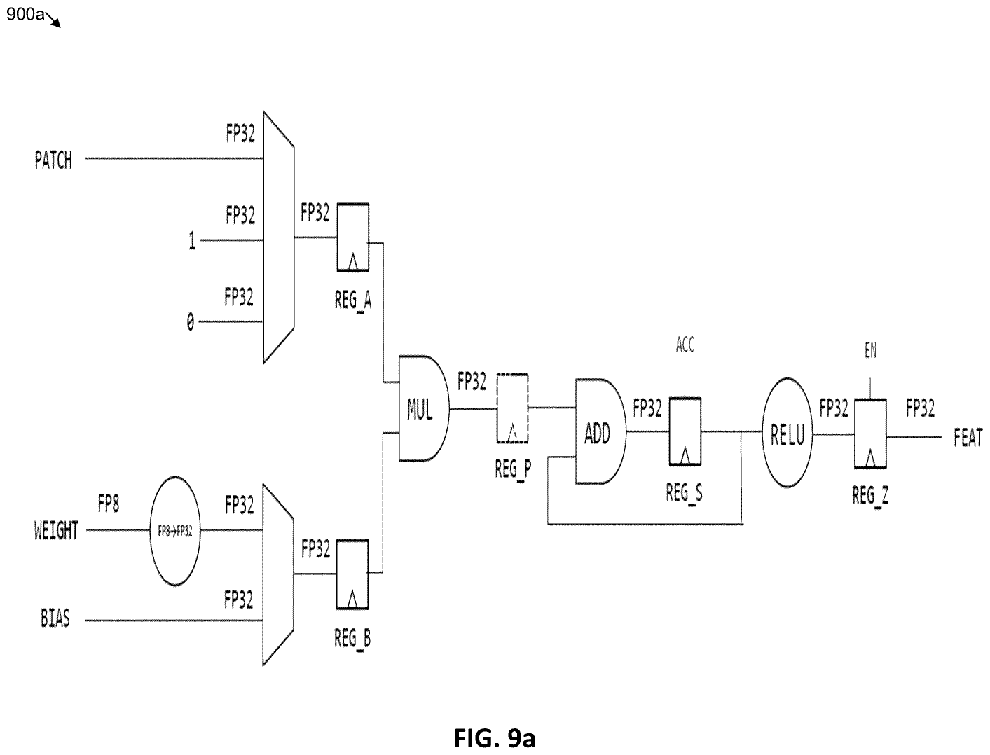

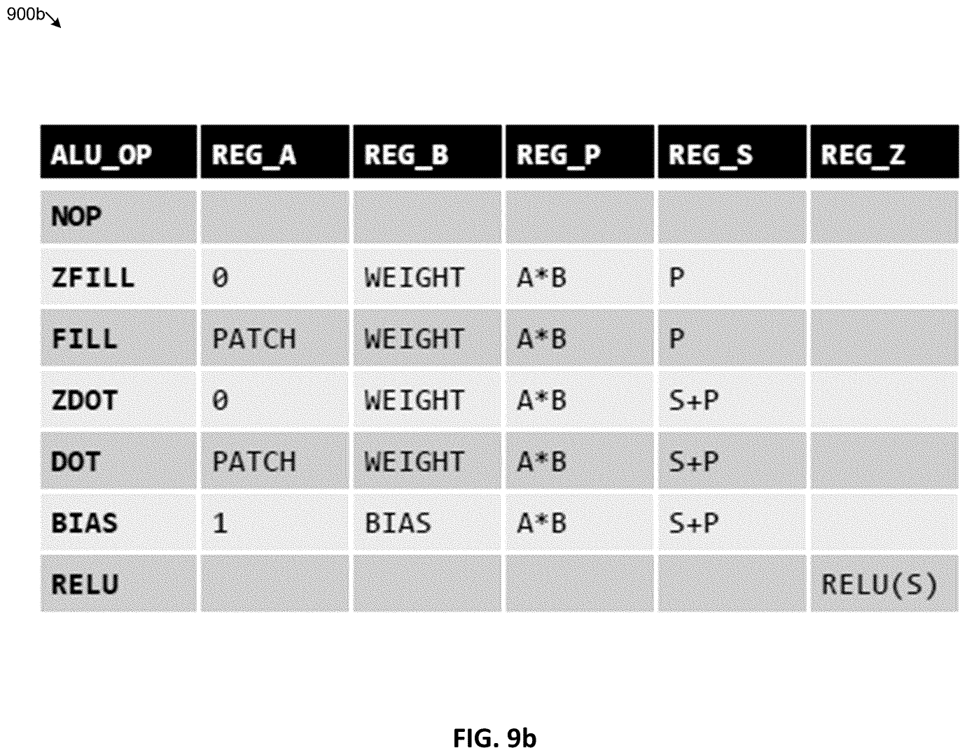

FIG. 9a is a block diagram depicting a floating point ALU, according to some embodiments. FIG. 9b depicts a table of values for the floating point ALU in FIG. 9a, according to some embodiments.

Still referring to FIGS. 9a-9b, the floating point ALU contains inputs {patch, weight, bias} and output feat. The ALU contains a multiply-accumulate unit which can be pipelined to an arbitrary depth. The control signal alu_op is decoded to produce multiplexer select signals for the A and B operands of the multiplier and the acc accumulate control signal. Using the appropriate sequence of alu_op values, the ALU can perform a pipelined dot product, followed by a bias addition, followed by a nonlinear activation. The M_FSM controls this sequence of alu_op values. The floating point ALU also contains logic to convert WTYPE to DTYPE, for example from FP8 to FP32. This conversion will be from lower to higher precision, so it only requires an adjustment to the exponent zero point.

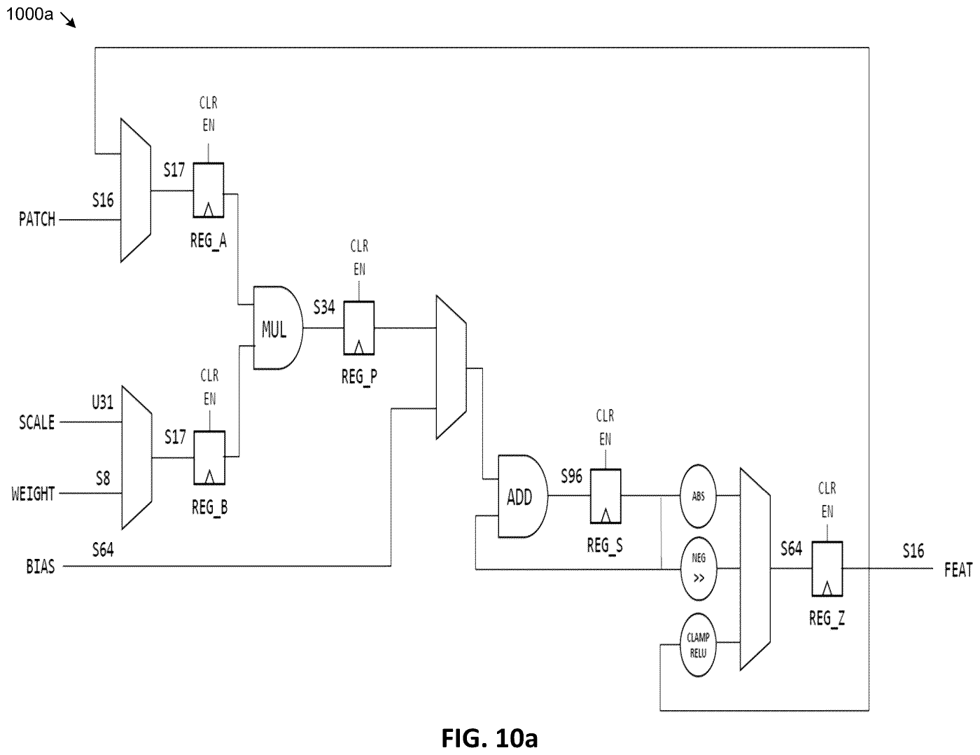

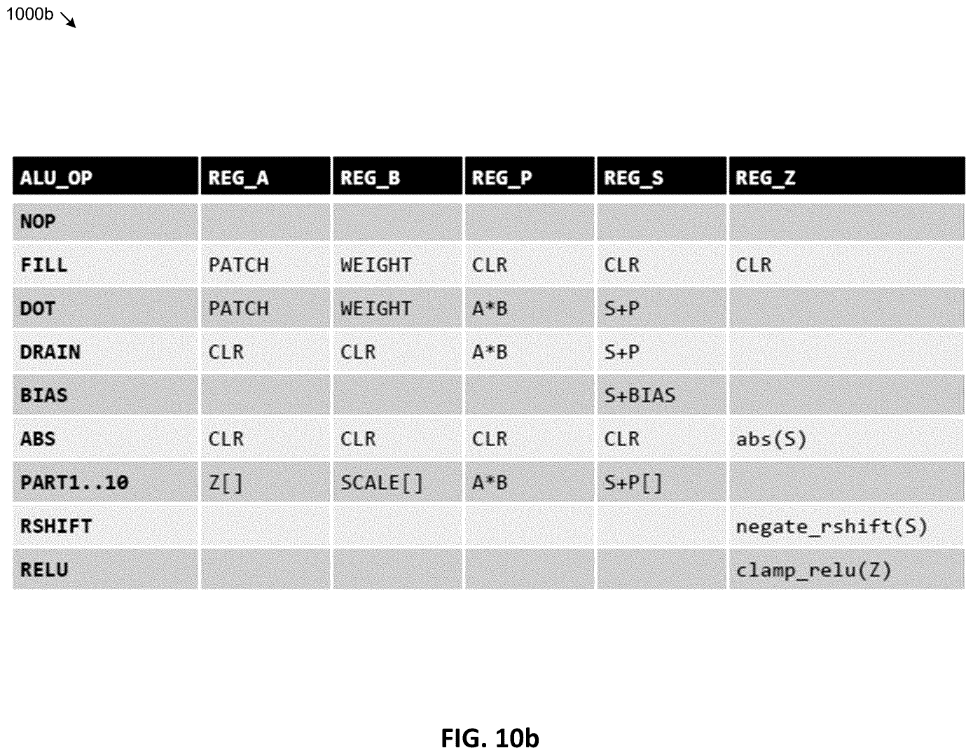

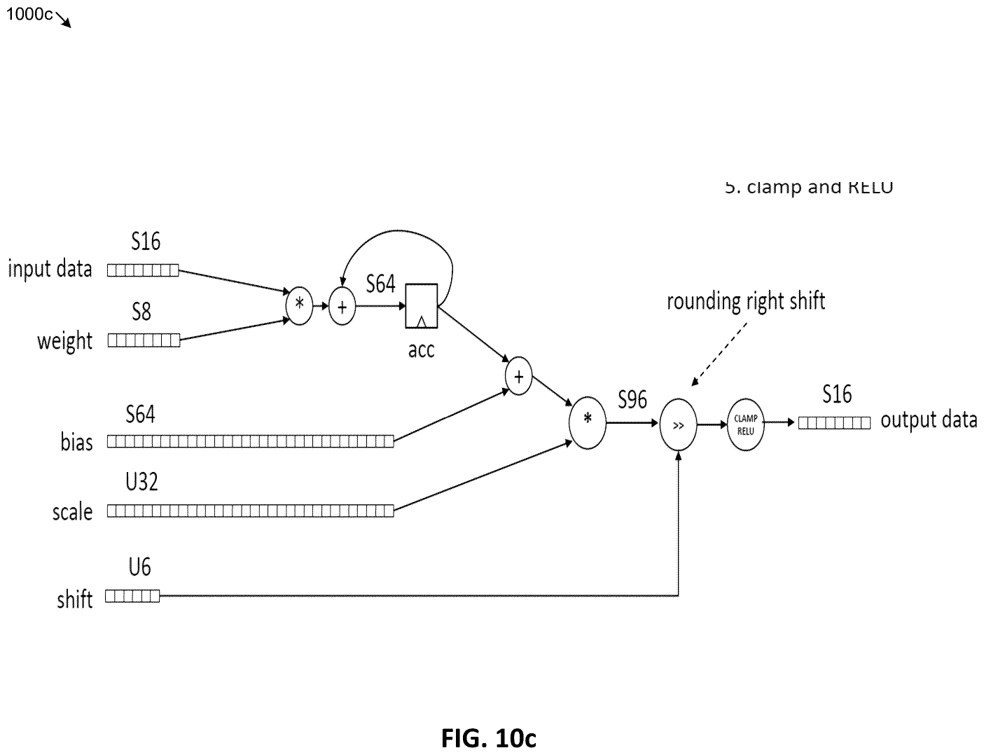

FIG. 10a is a block diagram depicting an integer ALU, according to some embodiments. FIG. 10b depicts a table of values for the integer ALU in FIG. 9a, according to some embodiments. FIG. 10c depicts a quantization and training of neural networks for efficient integer-arithmetic-only interference, according to some embodiments.

Still referring to FIGS. 10a-10c, the integer ALU contains a signed integer multiplier and a signed integer adder. The integer ALU supports quantized integer weight, bias and activation values. However, it requires a real value scale factor to be applied which involves a final high precision multiply and shift. In this method, the same multiplier hardware is used for the dot product and the real value scale factor.

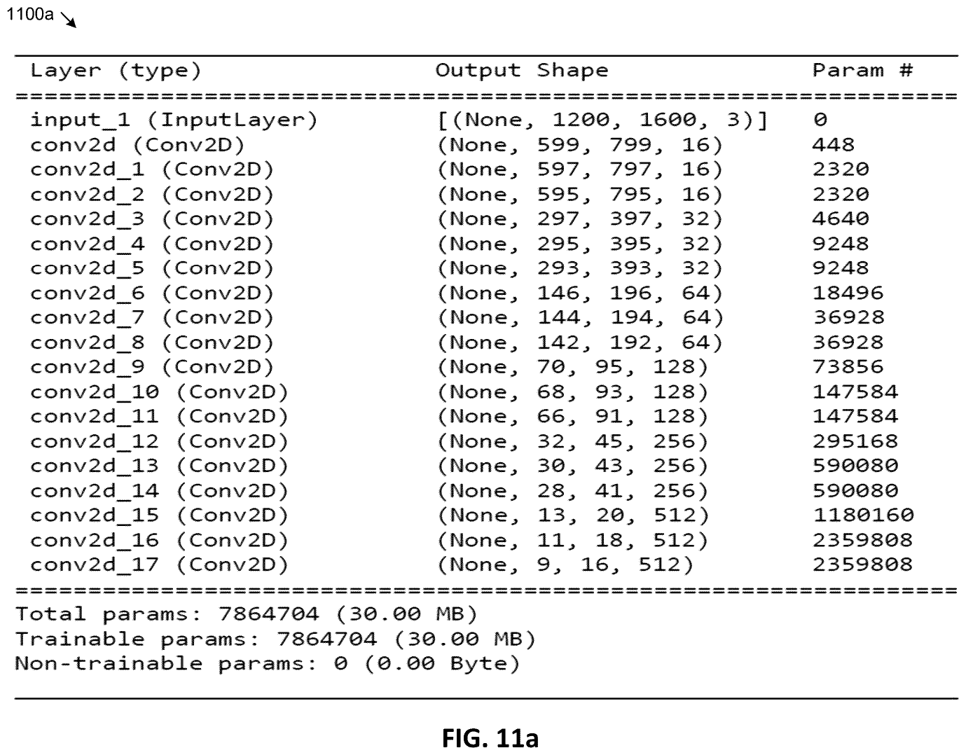

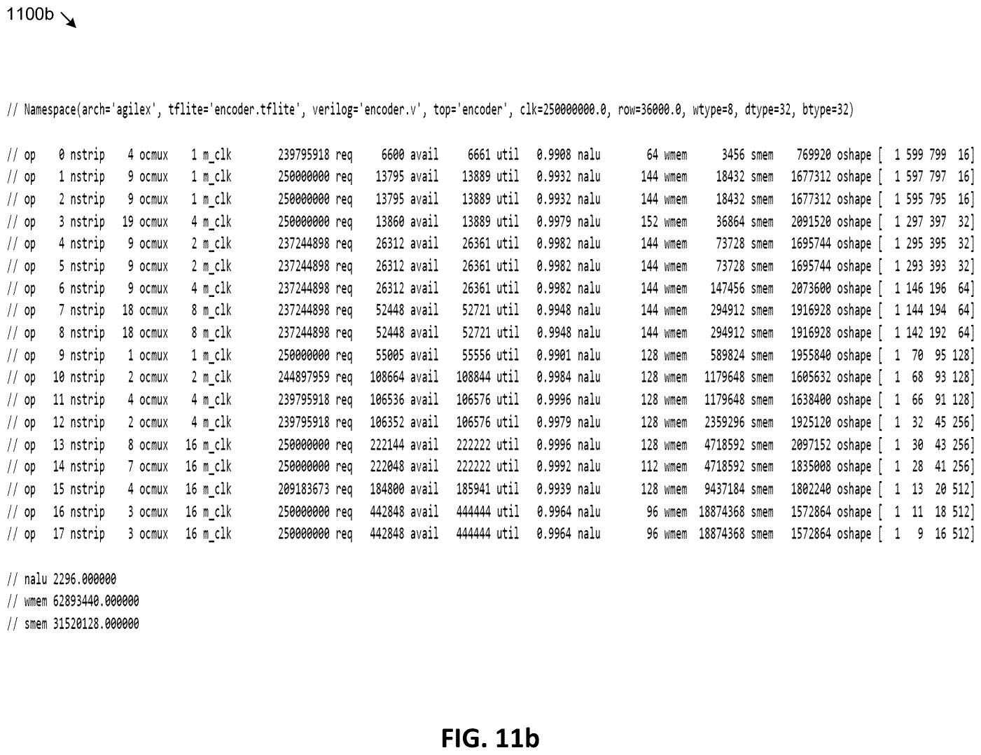

FIGS. 11a-11b depict tables of values representing an example image encoder CNN (e.g., streaming CNN 102 in FIG. 1) with 18 layers and 8M weights and based on a TensorFlow model architecture, according to some embodiments. The 18-layer CNN can be trained as a general-purpose image encoder which converts raw pixels into a feature map of high dimensional features (e.g., embeddings or tokens). This feature map can serve as the input to a downstream task, for example a transformer based vision-language model. Alternatively, the feature map can be trained to directly predict visual heat maps with no downstream model needed.

Using the performance parameter optimization procedure described herein with maximum row and clock rate set to 36 kilohertz (kHz) and 250 megahertz (MHz) respectively, the resulting NSTRIP, OCMUX and M_CLK parameters are shown in FIG. 10b. Note that a total of 2296 ALU units, 62.9 Mb weight memories, 31.5 Mb strip memories are instantiated. Using a larger model architecture would increase the ALU count and weight memory bits. Increasing the incoming row rate would increase the number of ALU units. Increasing the maximum M_CLK rate would decrease the number of ALU units. For a given CNN model architecture, in this case a VGG-like 18-layer feature pyramid, the clock rate can be smoothly traded against the silicon area. This allows embodiments which can run at relatively low frequency (e.g., 100 MHz), using highly parallel hardware. Running at a low clock rate enables the use of a broader range of silicon technology, for example using very high threshold (high Vt) transistors to reduce leakage power consumption, and/or using wafer scale or stacked die technology. Conversely, a very high clock rate can be used to achieve extremely high performance and/or minimum die area.

Similarly, for a given FPGA target device, the CNN parameters (e.g., model and performance) can be adjusted to utilize the maximum resources available in the device. This approach can be used to maximize the effective compute density of the FPGA. In addition, FPGA devices are typically sorted into speed grades from slowest to fastest. Using this method, a maximum M_CLK frequency can be chosen which meets timing requirements using the slowest speed grade. This approach can maximize the manufacturing yield of the FPGA devices.

The present embodiments provide an ability to automatically generate a range of CNN hardware implementations which cover the full range of power, performance, and/or die area (PPA) tradeoffs.

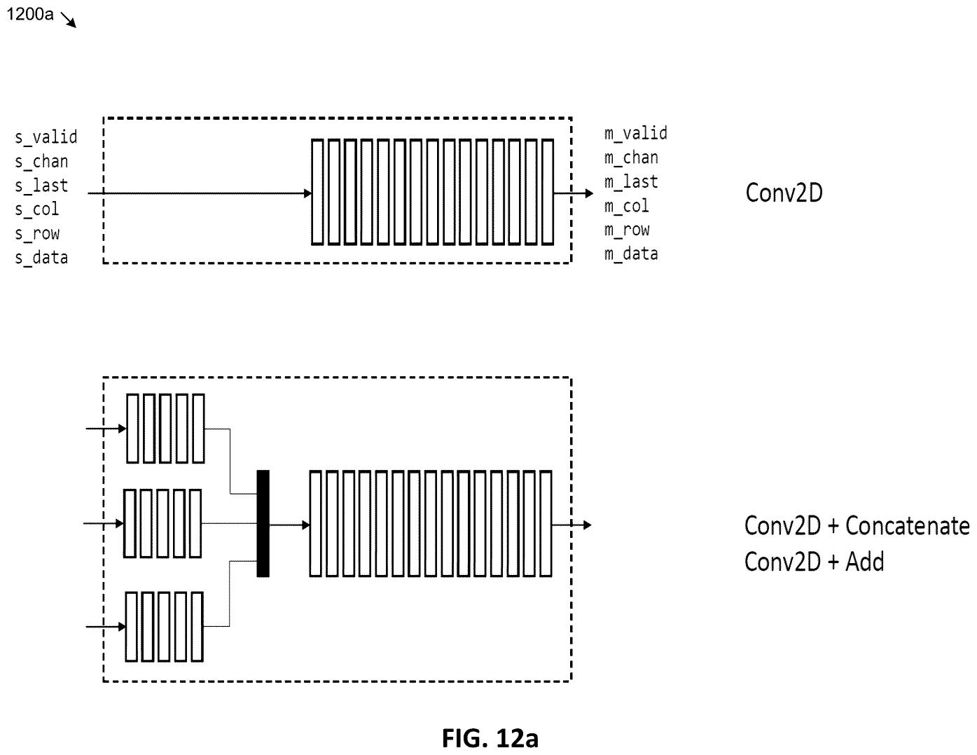

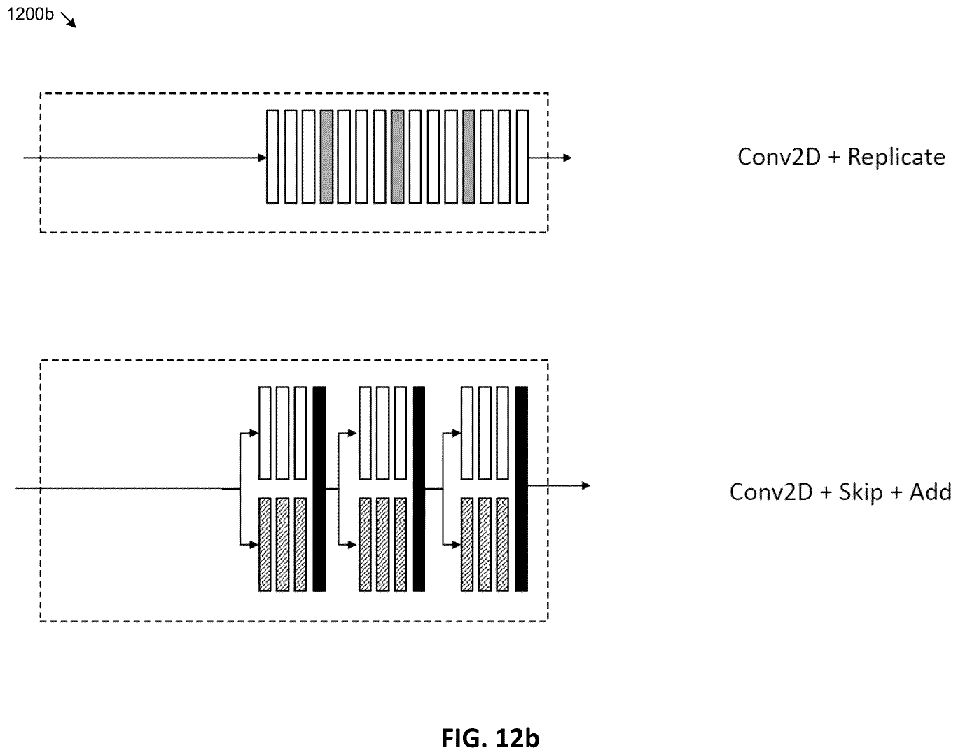

The basic method described above supports the subset of CNN architectures which topologically consist of a single sequence of Conv2D layers. Using the row-based streaming layer structure in this method, it is straightforward to extend the CNN hardware implementation method to include additional layer types. For example, FIGS. 12a-12b are block diagrams depicting four different types of Conv2D layers for the streaming CNN in FIG. 1, according to some embodiments. These additional layer types can be composed with the Conv2D base layer to create CNN architectures with different computation graph topologies.

To fuse the outputs of two or more Conv2D layers which have the same shape, the Concatenate layer can be used. In the Concatenate layer, there is a single stream output m_data and two or more stream inputs s_data0, s_data1, . . . which all have the same row rate. When a complete input row has arrived on all inputs, an output row is produced by concatenating the inputs in the input channel dimension, so m_data={s_data0, s_data1, . . . }. In some embodiments, the stream inputs can have different numbers of input channels.

Alternatively, the Add layer can be used to fuse multiple streams together. The Add layer is constructed similarly to the Concatenate layer. When the input rows have all arrived, the output feature is generated by adding the inputs per channel, so m_data=s_data0+s_data1+. Therefore in the Add layer, OCHAN=ICHAN.

The Replicate layer can be used to increase the size of the feature map in the height and width dimensions. The output is a 2×2 replication of every 1×1 input feature. By alternating the Replicate layer with Conv2D layers, trainable upsampling can be performed in the streaming CNN setting. Note that the Replicate layer increases the row rate by a factor of two.

To implement skip connections, the Skip layer can be used to buffer the intermediate tensors in the pipeline. The Skip layer contains a row buffer with two rows which alternate between send and receive. The function of the module is a one row delay line. The Skip layer can be used with the Add layer to implement streaming residual connections in the CNN. The Skip layer can also be implemented as a Concatenate layer with a single input.

Referring back to FIG. 1, the CNN system 101 may include one or more of the following features. In some embodiments, the CNN system 101 may be a streaming convolutional neural network hardware implementation, where input features are received continuously (e.g., with no flow control) and are processed at a maximum row rate.

In some embodiments, the CNN system 101 may include a top-level module which instantiates sequentially connected Conv2D layers with an interface protocol between layers which supports interleaved data transfers in the channel and column dimensions and/or may include an independent, asynchronous clock per layer.

In some embodiments, each Conv2D layer may be specified using three sets of parameters: (a) fixed functional parameters {ICHAN, IWIDTH, IHEIGHT, OCHAN, OWIDTH, OHEIGHT, KWIDTH, KHEIGHT, STRIDE, PAD, ACTIVATION} which fully capture the functional requirements of the layer, (b) adjustable implementation parameters {DTYPE, WTYPE, BTYPE} to specify the activation, weight, and bias data types, including floating point and integer formats, and (c) adjustable performance parameters {NSTRIP, OCMUX, M_CLK} which do not affect functionality and are used to generate the parallel data path depending on performance requirements and implementation constraints.

In some embodiments, the CNN system 101 may use a procedure to determine the optimal values for the performance parameters {NSTRIP, OCMUX, M_CLK} for each layer given the functional parameters, maximum row and M_CLK rates, feasibility constraints, and a cost function.

In some embodiments, the CNN system 101 uses corresponding parameterized Conv2D data path and control hardware design,

In some embodiments the CNN system 101 stores interleaved input features into NSTRIP individual true dual port memories, each with logical shape [IROW, ICOL+OVERLAP, ICHAN], organized as circular row buffers, using s_valid,s_data,s_last,s_row,s_col,s_chan.

In some embodiments, the CNN system 101 stores model weights in a single logical memory with shape [OCHAN, KHEIGHT, KWIDTH, ICHAN], along with an initialization mechanism.

In some embodiments, the CNN system 101 instantiates NSTRIP*(OCHAN/OCMUX) floating point or integer ALU units which compute the convolutional dot product and nonlinear output activation.

In some embodiments, the CNN system 101 emits interleaved output features using m_valid,m_data,m_last,m_row,m_col,m_chan.

In some embodiments, the CNN system 101 includes an S_FSM input feature counter to activate iterator M_FSM when a complete row has been received and is ready to be processed.

In some embodiments, the CNN system 101 includes an iterator M_FSM which implements the nested loop: foreach OROW→WAIT→foreach OCOL→OCHAN→EMIT(DOT(foreach KHEIGHT→KWIDTH→ICHAN))).

In some embodiments, the CNN system 101 includes one or more floating point ALUs that support arbitrary multiply-accumulate pipeline depth.

In some embodiments, the CNN system 101 includes one or more integer ALU hardware that uses a single 17×17 signed multiplier for the dot product and output scale factor.

In some embodiments, an RTL code generator may be used to realize the parameterized hardware design of the CNN system 101.

In some embodiments, the CNN system 101 includes parameterized Concatenate, Add, Replicate, Skip layers to support feature fusion, feature upscaling, skip connections.

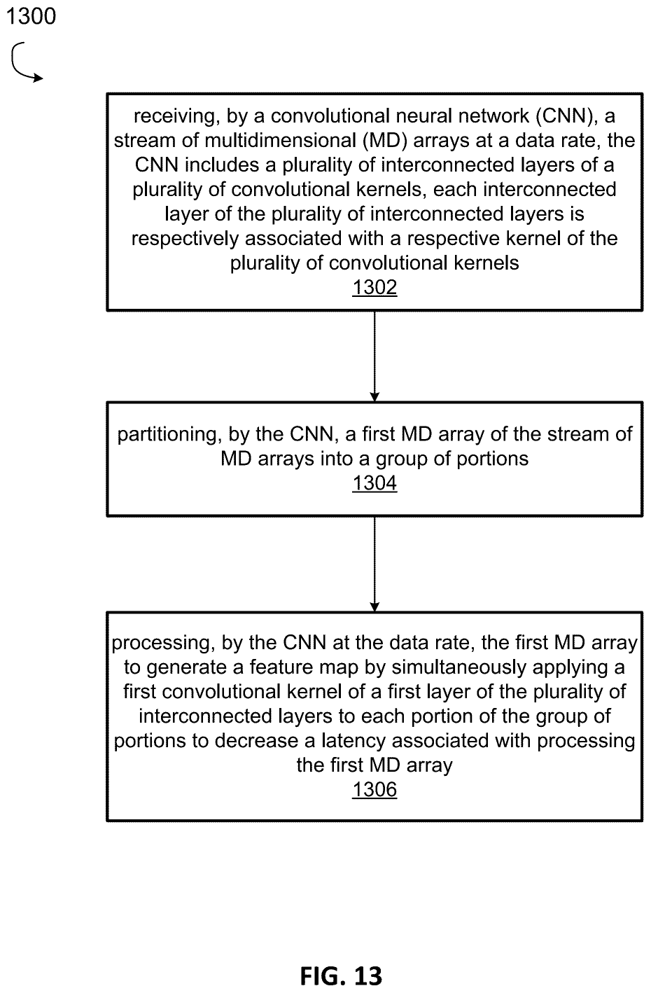

FIG. 13 is a flow diagram depicting a method of using a streaming CNN to process an incoming stream of MD arrays in real-time without having to control the flow rate of the incoming stream of MD arrays, according to some embodiments. Method 1300 may be performed by processing logic that may include hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. In some embodiments, method 400 may be performed by a CNN system, such as CNN system 101 in FIG. 1.

With reference to FIG. 13, method 1300 illustrates example functions used by various embodiments. Although specific function blocks (“blocks”) are disclosed in method 1300, such blocks are examples. That is, embodiments are well suited to performing various other blocks or variations of the blocks recited in method 1300. It is appreciated that the blocks in method 1300 may be performed in an order different than presented, and that not all of the blocks in method 1300 may be performed.

As shown in FIG. 13, the method 1300 includes the block 1302 of receiving, by a convolutional neural network (CNN), a stream of MD arrays at a data rate. The CNN includes a plurality of interconnected layers of a plurality of convolutional kernels. Each interconnected layer of the plurality of interconnected layers is respectively associated with a respective kernel of the plurality of convolutional kernels. The method 1300 includes the block 1304 of partitioning, by the CNN, a first MD array of the stream of MD arrays into a group of portions. The method 1300 includes the block 1306 of processing, by the CNN at the data rate, the first MD array to generate a feature map by simultaneously applying a first convolutional kernel of a first layer of the plurality of interconnected layers to each portion of the group of portions to decrease a latency associated with processing the first MD array.

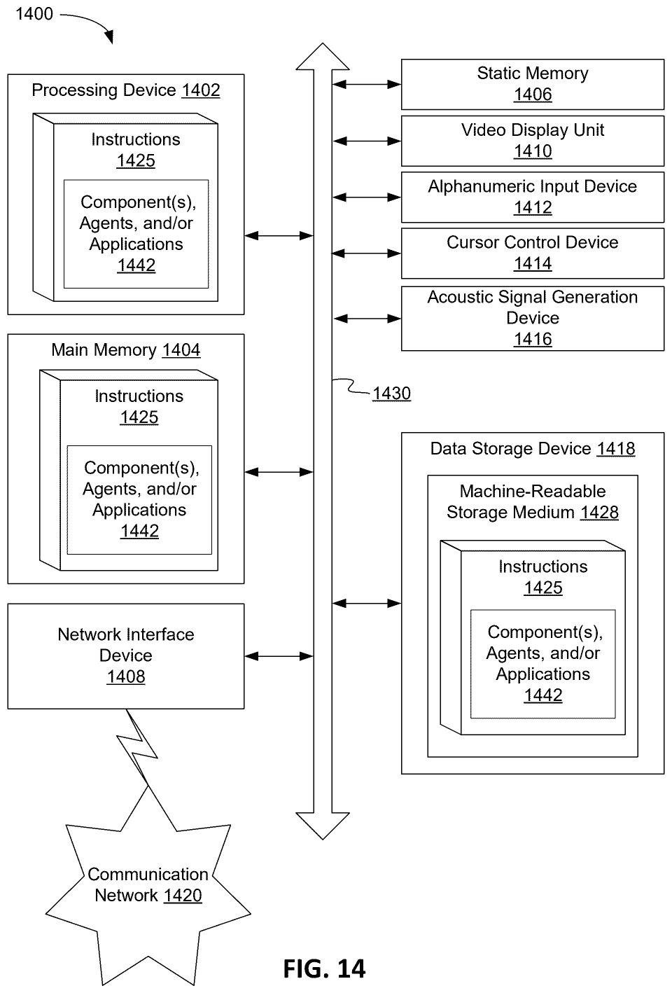

FIG. 14 is a block diagram of an example computing device 1400 that may perform one or more of the operations described herein, in accordance with some embodiments. Computing device 1400 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 1400 may include a processing device (e.g., a general-purpose processor, a PLD, etc.) 1402, a main memory 1404 (e.g., synchronous dynamic random-access memory (DRAM), read-only memory (ROM)), a static memory 1406 (e.g., flash memory and a data storage device 1418), which may communicate with each other via a bus 1430.

Processing device 1402 may be provided by one or more general-purpose processing devices such as a microprocessor, central processing unit, or the like. In an illustrative example, processing device 1402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 1402 may also include one or more special-purpose processing devices such as an application specific integrated circuit (ASIC), a field programmable gate array (FPGA), a digital signal processor (DSP), network processor, or the like. The processing device 1402 may be configured to execute the operations described herein, in accordance with one or more aspects of the present disclosure, for performing the operations and steps discussed herein.

Computing device 1400 may further include a network interface device 1408 which may communicate with a communication network 1420. The computing device 1400 also may include a video display unit 1410 (e.g., a liquid crystal display (LCD) or a cathode ray tube (CRT)), an alphanumeric input device 1412 (e.g., a keyboard), a cursor control device 1414 (e.g., a mouse) and an acoustic signal generation device 1416 (e.g., a speaker). In one embodiment, video display unit 1410, alphanumeric input device 1412, and cursor control device 1414 may be combined into a single component or device (e.g., an LCD touch screen).

Data storage device 1418 may include a computer-readable storage medium 1428 on which may be stored one or more sets of instructions 1425 that may include instructions for one or more components, agents, and/or applications 1442 (e.g., receivers 108, streaming CNNs 102, transformer-based neural network 104 in FIG. 1) for carrying out the operations described herein, in accordance with one or more aspects of the present disclosure. Instructions 1425 may also reside, completely or at least partially, within main memory 1404 and/or within processing device 1402 during execution thereof by computing device 1400, main memory 1404 and processing device 1402 also constituting computer-readable media. The instructions 1425 may further be transmitted or received over a communication network 1420 via network interface device 1408.

While computer-readable storage medium 1428 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving” “partitioning,” “processing,” “applying,” “generating,” “providing,” “reassembling,” “transmitting,” “retrieving,” “obtaining,” “adjusting,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method, comprising:
receiving, by a convolutional neural network (CNN), a stream of multidimensional (MD) arrays at a data rate, the CNN comprising a plurality of interconnected layers of a plurality of convolutional kernels, each interconnected layer of the plurality of interconnected layers is respectively associated with a respective kernel of the plurality of convolutional kernels;
partitioning, by the CNN, a first MD array of the stream of MD arrays into a group of portions; and
processing, by the CNN at the data rate, the first MD array to generate a feature map by simultaneously applying a first convolutional kernel of a first layer of the plurality of interconnected layers to each portion of the group of portions to decrease a latency associated with processing the first MD array.

2. The method of claim 1, wherein partitioning the first MD array into the group of portions comprises:
partitioning, by the first layer of the plurality of interconnected layers of the CNN, a first row of the first MD array into the group of portions; and
partitioning, by the first layer, a second row of the first MD array into a second group of portions.

3. The method of claim 2, wherein processing the first MD array to generate the feature map further comprises:
simultaneously applying, by the first layer, the first convolutional kernel of the first layer to each portion of the second group of portions.

4. The method of claim 2, wherein an overlap exists between the first row and the second row.

5. The method of claim 2, wherein applying the first convolutional kernel of the first layer to each portion of the group of portions comprises:
generating a first group of dot products based on the first convolutional kernel and the group of portions;
generating a second group of dot products based on the first convolutional kernel and the second group of portions;
providing, by the first layer in a sequential manner, the first group of dot products to a second layer of the plurality of interconnected layers of the CNN; and
providing, by the first layer in the sequential manner, the second group of dot products to the second layer of the plurality of interconnected layers of the CNN.

6. The method of claim 5, further comprising:
receiving, by the second layer, the first group of dot products and the second group of dot products; and
reassembling the first group of dot products and the second group of dot products on a row-by-row basis.

7. The method of claim 1, wherein processing the first MD array to generate the feature map further comprises:
transmitting, in parallel, a first set of output features from the first layer and a second set of output features from a second layer of the plurality of interconnected layers of the CNN.

8. The method of claim 7, further comprising:
receiving, by the CNN, a plurality of asynchronous clocks;
generating, by the first layer, the first set of output features based on a first asynchronous clock of the plurality of asynchronous clocks; and
generating, by the second layer, the second set of output features based on a second asynchronous clock of the plurality of asynchronous clocks.

9. The method of claim 1, wherein the first convolutional kernel is stored in a first memory space allocated to the first layer and a second convolutional kernel of the plurality of convolutional kernels is stored in a second memory space allocated to a second layer of the plurality of interconnected layers, and further comprising:
pipelining the first layer and the second layer by retrieving, in parallel, the first convolutional kernel from the first memory space for the first layer and the second convolutional kernel from the second memory space for the second layer.

10. The method of claim 1, further comprising:
obtaining a set of functionality parameters that define functionalities of the CNN;
obtaining a set of performance parameters that define performances of the CNN;
obtaining a set of implementation parameters that define parallel processing capabilities of the CNN; and
processing, by the CNN, the first MD array based on the set of functionality parameters, the set of performance parameters, and the set of implementation parameters.

11. The method of claim 10, further comprising at least one of:
obtaining an additional set of performance parameters that differ from the set of performance parameters; and
adjusting, by the CNN based on the additional set of performance parameters, a performance of the CNN without changing a functionality of the CNN, or
processing, by the CNN at the data rate, a second MD array of the stream of MD arrays to generate an additional feature map; and
providing, by the CNN, the feature map and the additional feature map to a model trained to detect real-time movement of an object indicated by the feature map and the additional feature map.

12. A convolutional neural network (CNN) comprising:
an interface to receive a stream of multidimensional (MD) arrays at a data rate;
a plurality of interconnected layers of a plurality of convolutional kernels coupled to the interface, each interconnected layer of the plurality of interconnected layers is respectively associated with a respective kernel of the plurality of convolutional kernels,
wherein the plurality of interconnected layers is to:
partition a first MD array of the stream of MD arrays into a group of portions; and
process, at the data rate, the first MD array to generate a feature map by simultaneously applying a first convolutional kernel of a first layer of the plurality of interconnected layers to each portion of the group of portions to decrease a latency associated with processing the first MD array.

13. The CNN of claim 12, wherein to partition the first MD array into the group of portions, the first layer is further to:
partition a first row of the first MD array into the group of portions; and
partition a second row of the first MD array into a second group of portions.

14. The CNN of claim 13, wherein to process the first MD array to generate the feature map, the first layer is further to:
simultaneously apply the first convolutional kernel of the first layer to each portion of the second group of portions.

15. The CNN of claim 13, wherein an overlap exists between the first row and the second row.

16. The CNN of claim 13, wherein to apply the first convolutional kernel of the first layer to each portion of the group of portions, the first layer is further to:
generate a first group of dot products based on the first convolutional kernel and the group of portions;
generate a second group of dot products based on the first convolutional kernel and the second group of portions;
provide, in a sequential manner, the first group of dot products to a second layer of the plurality of interconnected layers of the CNN; and
provide, by the first layer in the sequential manner, the second group of dot products to the second layer of the plurality of interconnected layers of the CNN.

17. The CNN of claim 16, further comprising:
receive, by the second layer, the first group of dot products and the second group of dot products; and
reassemble the first group of dot products and the second group of dot products on a row-by-row basis.

18. The CNN of claim 12, wherein to process the first MD array to generate the feature map, the plurality of interconnected layers is further to:
transmit, in parallel, a first set of output features from the first layer and a second set of output features from a second layer of the plurality of interconnected layers of the CNN.

19. The CNN of claim 18, wherein
the interface is further to receive a plurality of asynchronous clocks,
the first layer is to generate the first set of output features based on a first asynchronous clock of the plurality of asynchronous clocks; and
the second layer is to generate the second set of output features based on a second asynchronous clock of the plurality of asynchronous clocks.

20. The CNN of claim 12, further comprising:
a first memory space allocated to the first layer and to store the first convolutional kernel; and
a second memory space allocated to a second layer of the plurality of interconnected layers and to store a second convolutional kernel of the plurality of convolutional kernels,
wherein the CNN, the first memory space, and the second memory space are each disposed on the same integrated circuit (IC) device.

21. The CNN of claim 12, wherein the plurality of interconnected layers is to:
obtain a set of functionality parameters that define functionalities of the CNN;
obtain a set of performance parameters that define performances of the CNN;
obtain a set of implementation parameters that define parallel processing capabilities of the CNN; and
process the first MD array based on the set of functionality parameters, the set of performance parameters, and the set of implementation parameters.

22. The CNN of claim 21, wherein the plurality of interconnected layers is to:
obtain an additional set of performance parameters that differ from the set of performance parameters; and
adjust, based on the additional set of performance parameters, a performance of the CNN without changing a functionality of the CNN.

23. A non-transitory computer-readable medium storing instructions that, when executed by a processing device of a convolutional neural network (CNN), cause the processing device to:
receive a stream of multidimensional (MD) arrays at a data rate, the CNN comprising a plurality of interconnected layers of a plurality of convolutional kernels, each interconnected layer of the plurality of interconnected layers is respectively associated with a respective kernel of the plurality of convolutional kernels;
partition, by the processing device, a first MD array of the stream of MD arrays into a group of portions; and
process, at the data rate, the first MD array to generate a feature map by simultaneously applying a first convolutional kernel of a first layer of the plurality of interconnected layers to each portion of the group of portions to decrease a latency associated with processing the first MD array.
